(19) United States
(12) Patent Application Publication
(10) Pub. No.: US 2026/0175826 A1
(43) Pub. Date: Jun. 25, 2026

(54) Electro-Pneumatic Structural Unit and Electro-Pneumatic Brake Device With Double Redundancy and Brake Slip Control

(71) Applicant: KNORR-BREMSE Systeme fuer Nutzfahrzeuge GmbH, Muenchen (DE)

(72) Inventor: Max MICHALSKI, Neubiberg (DE)

(21) Appl. No.: 19/126,285

(22) PCT Filed: Oct. 24, 2023
(86) PCT No.: PCT/EP2023/079551

§ 371 Date: May 1, 2025

(30) Foreign Application Priority Data
Nov. 2, 2022 (DE) 10 2022 128 947.8

(51) Int. Cl. B60T 13/66; B60T 13/38

(52) U.S. Cl. CPC B60T 13/665; B60T 13/385

(57) ABSTRACT

An electro-pneumatic structural unit is at least designed and configured to control an electro-pneumatic brake device in at least two redundancies, a first redundancy and a second redundancy, for an electro-pneumatic service brake device of the electro-pneumatic brake device of a motor vehicle designed to pull a trailer, when a normal operation of the electro-pneumatic service brake device is not possible

### BACKGROUND AND SUMMARY

The present invention relates to an electro-pneumatic structural unit, an electro-pneumatic brake device, and a motor vehicle.

During “manual driving”, the driver operates the motor vehicle in terms of its longitudinal and lateral guidance. Even when the longitudinal and lateral guidance can be assisted or partially even undertaken by driver assistance systems, the driver remains responsible for the motor vehicle and is obliged to monitor all important operating functions.

Within the scope of a “partially automated driving” operating mode, driver assistance systems are known which warn the driver of collisions, for example, and possibly also attempt to avoid collisions by means of interventions. Examples of such driver assistance systems are an emergency brake assistant, a lane-keeping assistant, a blind spot assistant, a parking assistant and so-called Automatic Cruise Control (ACC), in particular for freeway journeys.

In contrast, during “highly automated driving”, there is an at least temporary transfer of the responsibility to regulation technology. The system for guiding the vehicle is then designed such that it can completely undertake the guidance of the vehicle at least for a certain time and for example in a defined environment (for example on freeways). The driver is then also no longer obliged to monitor the regulation functions. However, since critical situations may still arise (for example failure of the sensor system, confusing traffic situations, etc.), the system may also return the responsibility for guidance to the driver. So that this can happen, it must be ensured that the driver can assume the guidance of the motor vehicle again in a time window of a few seconds. The “highly automated driving” operating mode is therefore distinguished by the fact that the driver need not continuously monitor the guidance of the motor vehicle at least for a defined period and in defined situations. However, the driver must remain able to assume the guidance of the motor vehicle again in an appropriate time. The “highly automated driving” operating mode can also be distinguished from the “manual driving” and “partially automated driving” operating modes in that the vehicle drives in a fully automatic manner for a driving distance input using a navigation system in the “highly automated driving” operating mode, in which case the vehicle is automatically accelerated, braked and steered via an electronic system.

Highly automated driving (HAD Highly Autonomous Driving) therefore presumes knowledge of the environment of the vehicle. For this purpose, the environment is scanned or recorded using one or more sensors such as radar, lidar, a camera, ultrasonic sensors or similar sensors known from the prior art. The occupancy of the environment by objects is then identified with the aid of the sensor measurements using signal processing methods which are likewise known in the prior art. The occupancy indicates that the environment cannot be traversed by the vehicle in a certain section and therefore indicates the position of the object. The type of objects is additionally identified, that is to say whether the objects are pedestrians, vehicles, road boundaries, traffic lights etc. The identified occupancies and types of objects are used to create an environmental model which provides information or data relating to the occupancy of the environment by objects, that is to say in particular the sections of the environment that are occupied by objects, and the type of objects.

According to the definition of SAE (Society of Automotive Engineers) J3016, the degrees of automation during driving are summarized in 5 levels. The term “system” represents either a driver assistance system, a combination of individual driver assistance systems or a completely autonomous drive, brake and steering system. The degree of automation becomes increasingly comprehensive; it begins with systems which inform or warn the driver (level 0) and then continues with systems which undertake either only the longitudinal or lateral guidance of the vehicle, in which case the driver always has the responsibility for observing the environment and/or of stepping in as a fallback solution (level 1). Even more comprehensive automation is provided by level 2 systems which already undertake the longitudinal and lateral guidance of the vehicle, but the observation of the environment and the fallback level still remain with the driver (level 2). Level 3 systems guide the vehicle automatically without the driver having to observe the environment, but he must still act as the fallback level. In level 4, the system is already fully responsible for guiding the vehicle and must provide appropriate system-related fallback solutions in the event of failure. Level 5 differs from level 4 only in that the automated vehicle guidance must function under all conditions, but this is restricted to selected situations in level 4.

Motor vehicles having highly automated driving functions which relieve the driver of the guidance task and responsibility at least for a limited time must continue to guide the vehicle, if any fault occurs, until the driver assumes responsibility again. The “failsafe” system property derived therefrom requires basic functions, such as braking and steering, to still be ensured, at best without functional restrictions. This means, for example, that, in the event of any fault, the vehicle must still be able to be braked and steered with electronic control within a certain framework.

A sensor system for generating environment information, a main control unit and a backup control unit are provided in DE 10 2013 020 177 A1 for at least partially autonomous operation of a motor vehicle, wherein, in a nominal operating state, the main control unit controls the sensor systems and, if the main control unit fails, the backup control unit controls the sensor systems.

The object of the present invention is to provide an electro-pneumatic structural unit, an electro-pneumatic brake device and a motor vehicle, in which higher reliability of the brake functions is ensured.

This object is achieved by means of the apparatuses indicated in the independent claim(s). Further advantageous configurations and developments of the invention emerge from the dependent claims.

According to a first aspect, the invention discloses an electro-pneumatic structural unit which is at least designed and configured to control, in at least two redundancies, a first (electrical) redundancy and a second (electrical) redundancy, for an electro-pneumatic service brake device of an electro-pneumatic brake device of a motor vehicle designed to tow a trailer, the electro-pneumatic brake device when normal operation of the electro-pneumatic service brake device, in which a primary service brake pressure is generated by the electro-pneumatic service brake device, is not possible, wherein the electro-pneumatic structural unit comprises at least the following:
a) a first electrical structural unit input connection for introducing an electrical service brake request signal,
b) at least one first pneumatic structural unit output connection for outputting a pneumatic redundancy service brake pressure to at least one pneumatic service brake cylinder,
c) at least one second pneumatic structural unit output connection for outputting a pneumatic brake pressure to at least one pneumatic spring-loaded brake cylinder,
d) an electronic control unit controlled at least by the electrical service brake request signal introduced at the first electrical structural unit input connection,
e) a first structural unit device which is controlled by the electronic control unit, comprises at least one solenoid valve and is connected at least to the first pneumatic structural unit output connection,
f) a second structural unit device which is controlled by the electronic control unit, comprises at least one solenoid valve and is connected to the second structural unit output connection, wherein
g) the electronic control unit is designed
   g1) to control the first structural unit device within the scope of the first redundancy, when normal operation of the electro-pneumatic service brake device is not possible, on the basis of the electrical service brake request signal introduced at the electrical structural unit input connection in such a manner that the redundancy service brake pressure is output at the first structural unit output connection in order to engage the at least one service brake cylinder, and
   g2) to control the second structural unit device within the scope of the second redundancy, when normal operation of the electro-pneumatic service brake device is not possible and the first redundancy has also failed, on the basis of the electrical service brake request signal introduced at the first electrical structural unit input connection in such a manner that the pneumatic brake pressure is output at the second structural unit output connection in order to engage the at least one spring-loaded brake cylinder.

An electro-pneumatic structural unit is intended to be understood as meaning a structural unit having electrical/electronic and pneumatic components, wherein the structural unit has its own housing or a plurality of housings flanged to one another, in which the electrical/electronic and pneumatic components of the electro-pneumatic structural unit are then accommodated.

A structural unit device is an integral component part of the electro-pneumatic structural unit and may comprise electrical/electronic and/or pneumatic components, for example solenoid valves, pneumatic valves, regulation valves, relay valves and pneumatic and/or electrical connections. For example, one or more particular functions are assigned to a structural unit device, for example a compressed air treatment function, a parking brake function, a service brake function or a trailer control function.

The “normal operation” of the electro-pneumatic service brake device is intended to be understood as meaning that the electro-pneumatic service brake device generates a primary service brake pressure corresponding to the electrical brake request signal. In this case, the electrical brake request signal represents a target primary service brake pressure.

The electro-pneumatic service brake device is preferably an EBS, that is to say an electronically regulated brake system, in which an actual service brake pressure is adjusted to a target brake pressure.

The electro-pneumatic structural unit is configured and designed, in particular, to perform, at least during normal operation, the parking brake brake function, which comprises engaging and releasing the parking brake or the at least one spring-loaded brake cylinder, and optionally at least one further parking brake function such as a test function, which involves determining whether the combination of the motor vehicle and coupled trailer can be kept at a standstill by the spring-loaded brake cylinders engaged only in the motor vehicle. The pneumatic brake pressure can therefore be a pneumatic parking brake pressure, in particular.

On the other hand, the electro-pneumatic structural unit, which, for example according to a further aspect of the invention, is provided in the electro-pneumatic brake device in addition to the electro-pneumatic service brake device, provides the control of the electro-pneumatic brake device within the scope of the first and second redundancy. Consequently, all control functions of the electro-pneumatic brake device for the first and second redundancy are preferably combined in the electro-pneumatic structural unit. The electro-pneumatic structural unit can then advantageously form, for example, a retrofit component for an already existing electro-pneumatic brake device in order to provide the first and second redundancy. Furthermore, cabling systems and their contact points are saved by integrating various components and systems in one structural unit.

It is also important that it is possible to operate the motor vehicle both in the first redundancy and in the second redundancy at an undiminished high speed in comparison with normal operation because at least the ABS regulation is preferably retained in the first and second redundancy. In addition, further regulation processes, for example a driving dynamics regulation system (ESP) and/or traction regulation, can also be retained in the first redundancy and optionally also in the second redundancy.

Within the scope of the first redundancy, when normal operation of the electro-pneumatic service brake device is not possible, the electro-pneumatic structural unit generates a redundancy service brake pressure as a substitute for the primary service brake pressure in order to engage the at least one service brake cylinder during requested service braking according to the service brake request signal.

Within the scope of the second redundancy, when both normal operation of the electro-pneumatic service brake device is not possible and the first redundancy has failed, that is to say when a redundancy service brake pressure can no longer be generated either, the electro-pneumatic structural unit outputs a pneumatic brake brake pressure in order to engage the at least one spring-loaded brake cylinder (in metered fashion) during requested service braking on the basis of the brake request signal. The requested service braking is therefore carried out in the second redundancy using the at least one spring-loaded brake cylinder instead of using the at least one service brake cylinder.

The first redundancy and the second redundancy both form electrical redundancies because they are each controlled by the electrical control unit of the electro-pneumatic structural unit.

The parking brake function(s) (at least engaging/releasing of the parking brake) preferably implemented in the electronic control unit of the electro-pneumatic structural unit is/are preferably also intended to be provided in the first and second redundancy, for which purpose the electronic control unit of the electro-pneumatic structural unit is designed accordingly.

The parking brake control integrated in the electronic control unit of the electro-pneumatic structural unit therefore advantageously provides a dual function by providing, on the one hand, the parking brake function(s) (at least engaging/releasing of the parking brake) preferably during normal operation and preferably also in the first redundancy and in the second redundancy, but, on the other hand, also enabling service braking in the second redundancy by engaging the spring-loaded brake cylinders, in particular in metered fashion, on the basis of the service brake request signal. Depending on the level of the pneumatic brake pressure, in particular pneumatic parking brake pressure, output by the electro-pneumatic structural unit, the spring-loaded brake cylinders can then be engaged gradually, in stages or continuously (in metered fashion), which increases the comfort and reliability of the service braking in the second redundancy, because the spring-loaded brake cylinders are then not engaged abruptly, for example with a constant or maximum parking brake force.

The parking brake control function(s) and the redundant service brake control function for the motor vehicle and in particular for the trailer are therefore preferably implemented in the integrated electronic control unit. Furthermore, further functions such as a compressed air treatment function and a trailer brake control function can also be implemented there. The integrated electronic control unit may have partitions on at least one control board, wherein each partition performs its own control function (parking brake function, service brake function, compressed air treatment function, trailer brake control function).

For the reasons mentioned above, the electro-pneumatic structural unit according to the first aspect of the invention results in greater reliability for the brake functions of the motor vehicle.

According to one development, the electro-pneumatic structural unit may comprise at least one second electrical structural unit input connection for introducing an electrical parking brake request signal, wherein the electronic control unit is designed to control the second structural unit device, within the scope of a parking brake function, on the basis of the electrical parking brake request signal introduced at the second electrical structural unit input connection, to output the pneumatic parking brake pressure at the second structural unit output connection.

In order to provide driving dynamics regulation functions such as ABS in the first redundancy and in the second redundancy, the electro-pneumatic structural unit may comprise at least one third electrical structural unit input connection which is designed to introduce at least one electrical signal into the integrated electronic control unit, which is at least one of the following electrical signals: a wheel-speed-dependent signal representing a wheel speed of at least one wheel of the motor vehicle and/or of the trailer, and/or a rotation-rate-dependent signal representing a rotation rate of the motor vehicle and/or of the trailer, and/or a steering-angle-dependent signal representing a steering angle or steering wheel angle of the motor vehicle, and/or a longitudinal-acceleration-dependent or lateral-acceleration-dependent signal representing a longitudinal and/or lateral acceleration of the motor vehicle and/or of the trailer.

Alternatively or additionally, the electrical signal may also be a signal which represents the speed of the motor vehicle and originates, for example, from a further electronic control unit of the motor vehicle and is transmitted from the latter to the electro-pneumatic structural unit, for example via a data bus. Therefore, any signals which influence the driving dynamics and/or driving stability of the motor vehicle and/or of the trailer are possible as electrical signals that can be received and processed by the electro-pneumatic structural unit.

The electro-pneumatic structural unit can therefore be configured and designed to process at least some of the electrical signals, in particular for the purpose of driving dynamics and/or driving stability regulation. Driving stability regulation (ESP), for example, can be implemented in the first redundancy and optionally also in the second redundancy using the electrical signals mentioned above.

In particular, wheel speed signals from a plurality of wheels, in particular from all wheels of the motor vehicle, are introduced into the integrated electronic control unit in order to enable ABS brake slip regulation in the first redundancy and in particular also in the second redundancy on the basis thereof.

This makes it possible for the electronic control unit which is integrated in the electro-pneumatic structural unit and is connected to the third electrical structural unit input connection to perform driving dynamics regulation, in particular an ABS function and/or driving stability regulation (ESP), on the basis of at least one of the electrical signals mentioned above, which is then implemented in the integrated electronic control unit, for example.

For example, the electro-pneumatic structural unit may have at least one first electrical structural unit output connection for at least one ABS pressure control valve. As already stated above, ABS regulation, in particular, may be implemented in the integrated electronic control unit and is designed to output an electrical control signal, in particular an ABS control signal for the ABS pressure control valve, to the first electrical structural unit output connection at least on the basis of the electrical signal introduced at the third electrical structural unit input connection.

The electro-pneumatic structural unit is preferably connected to a CAN data bus and exchanges, via the CAN data bus, signals and data with other control units, for example with a central brake control unit, in particular with regard to monitoring the function of the central brake control unit. For the data bus capability, the electro-pneumatic structural unit may have a data bus interface. In particular, some or all electrical structural unit input connections may also be combined in a common CAN connection of the electro-pneumatic structural unit.

According to one development, the integrated electronic control unit may be designed such that at least one regulation process of the following regulation processes is performed within the scope of the first redundancy and/or within the scope of the second redundancy:
ABS regulation, and/or
ASR regulation, and/or
ESP regulation.

For example, the at least one ABS pressure control valve can reduce, maintain or increase the redundancy service brake pressure output by the electro-pneumatic structural unit and/or the parking brake pressure output by the electro-pneumatic structural unit within the scope of the second redundancy in order to adapt the actual brake slip recorded using the wheel speeds to a target brake slip.

A loss of function or a degradation with regard to driving dynamics regulation functions is therefore avoided in the first redundancy and in the second redundancy, which likewise contributes to a higher functional reliability.

According to one preferred development, the electro-pneumatic structural unit may also comprise a third structural unit device having at least one solenoid valve as well as a third pneumatic structural unit output connection connected to the third structural unit device. In this case, the integrated electronic control unit may be designed to control the third structural unit device on the basis of the electrical service brake request signal in such a manner that a pneumatic trailer brake pressure for at least one trailer of the motor vehicle is generated at the third pneumatic structural unit output connection. A “brake” coupling head for the trailer, in particular, may be connected to the third pneumatic structural unit output connection. Trailer control functions are then implemented in the integrated electronic control unit. In particular, the trailer brakes can then be controlled, in particular in the first and second redundancy, with the aid of the electro-pneumatic structural unit.

Further preferably, the electro-pneumatic structural unit comprises a fourth structural unit device having solenoid valves, which forms an integrated electro-pneumatic compressed air treatment device. The integrated electronic control unit is then designed to perform a known compressed air treatment function by controlling the fourth structural unit device. The fourth structural unit device can then comprise, in particular, a pressure regulator, an air dryer and a multi-circuit protection valve. The electro-pneumatic structural unit also preferably has a pneumatic structural unit connection, in particular a compressor connection, which is provided for connection to a compressed air outlet of a compressor.

The fourth structural unit device integrated in the electro-pneumatic structural unit then supplies at least one compressed air reservoir with compressed air and has, for this purpose, at least one structural unit reservoir connection, to which the relevant compressed air reservoir is then connected.

The electro-pneumatic brake device has at least a two-circuit design here, for example, wherein a first circuit (for example a front or rear axle service brake circuit) is supplied with compressed air by a first reservoir pressure of a first compressed air reservoir and a second circuit is supplied with compressed air by a second reservoir pressure of a second compressed air reservoir. A trailer brake circuit can then be supplied with compressed air by the first circuit or the second circuit or by a separate trailer compressed air reservoir.

A further aspect of the invention discloses an electro-pneumatic brake device for a motor vehicle suitable for coupling a trailer. The electro-pneumatic brake device comprises at least the following:
a) the electro-pneumatic structural unit described above,
b) the electro-pneumatic service brake device (EBS) comprising at least the following:
   b1) a primary service brake control unit,
   b2) at least one electro-pneumatic pressure regulation module electrically controlled by the primary service brake control unit, and
   b3) the at least one service brake cylinder which is connected to a pneumatic pressure regulation module output connection of the pressure regulation module, wherein the primary service brake control unit electrically controls the pressure regulation module, on the basis of the electrical service brake request signal, to output the primary service brake pressure at the pressure regulation module output connection.

Such an electro-pneumatic pressure regulation module is known from the prior art and comprises an integrated local control unit which controls an inlet/outlet solenoid valve combination connected to a compressed air reservoir according to a brake request introduced into the local control unit. The control pressure generated by the inlet/outlet solenoid valve combination on the basis of the reservoir pressure originating from the compressed air reservoir then controls a relay valve which is likewise connected to the compressed air reservoir on the reservoir side and then modulates a brake pressure for a connected service brake cylinder from the control pressure. An integrated pressure sensor measures the actual brake pressure and reports it to the integrated control unit which then, for the purpose of brake pressure regulation, adjusts the actual brake pressure to a target brake pressure corresponding to the brake request. Furthermore, a backup valve is also integrated as a solenoid valve in such a pressure regulation module, which backup valve closes when energized and prevents a backup pressure, which is present at a backup connection and originates, in particular, from a pneumatic channel of a foot brake valve, from being forwarded to the relay valve. In contrast, the backup valve opens when deenergized, which may be based on a defect of the local control unit, in the electrical energy supply and/or in the control by means of the brake request signal, and then forwards the backup pressure to the relay valve which then modulates the service brake pressure on the basis of the backup pressure. The backup pressure then achieves purely pneumatic redundancy which is only intended to be optional here, however. A pressure regulation module may be of single-channel design, that is to say for regulating a brake pressure at a wheel or at an axle, and of multi-channel design, that is to say for regulating a brake pressure at a plurality of wheels, for example on an axle.

The electro-pneumatic brake device may also have an electro-pneumatic parking brake device which comprises the pneumatic spring-loaded brake cylinder, which is connected to the second pneumatic structural unit output connection, an electrical parking brake actuating device, the integrated electronic control unit and the second structural unit device, wherein the integrated electronic control unit controls the second structural unit device, on the basis of the electrical parking brake request signal generated by the electrical parking brake actuating device and introduced into the second electrical structural unit input connection, to output the pneumatic brake pressure, in particular a pneumatic parking brake pressure, to at least one pneumatic spring-loaded brake cylinder at the second pneumatic structural unit output connection.

Furthermore, a pneumatic pressure line may be laid in the electro-pneumatic brake device between a pressure regulation module backup connection of the pressure regulation module and the first pneumatic structural unit output connection.

Furthermore, the electro-pneumatic brake device may have at least one of the following sensors: at least one wheel speed sensor designed and configured to generate wheel-speed-dependent signals, and/or at least one rotation rate sensor designed and configured to generate rotation-rate-dependent signals, and/or at least one steering angle sensor designed and configured to generate steering-angle-dependent signals, and/or at least one acceleration sensor designed and configured to generate longitudinal-acceleration-dependent and/or lateral-acceleration-dependent signals.

In the electro-pneumatic brake device, the electro-pneumatic structural unit may also be designed and configured to directly receive and process the signals from the at least one sensor at the third electrical structural unit input connection, wherein the at least one wheel speed sensor is connected to the third electrical structural unit input connection of the electro-pneumatic structural unit, and/or the at least one rotation rate sensor is connected to the third electrical structural unit input connection of the electro-pneumatic structural unit, and/or the at least one steering angle sensor is connected to the third electrical structural unit input connection of the electro-pneumatic structural unit, and/or the at least one acceleration sensor is connected to the third electrical structural unit input connection of the electro-pneumatic structural unit (GSAT).

Alternatively, in the electro-pneumatic brake device, the electro-pneumatic structural unit may be designed and configured to process the signals from the at least one sensor and to indirectly receive signals from a further electronic control unit of the motor vehicle, in particular via a data bus, to which the electro-pneumatic structural unit and the further electronic control unit are connected.

A pneumatic pressure line may also be provided in the electro-pneumatic brake device between the first pneumatic structural unit output connection and a “brake” coupling head.

Furthermore, the electro-pneumatic brake device may comprise at least one first ABS pressure control valve arranged between the pressure regulation module output connection of the pressure regulation module and the pneumatic service brake cylinder.

The first ABS pressure control valve may be controlled by the primary service brake control unit during normal operation on the basis of the electrical signal in such a manner that it adapts the primary service brake pressure output at the pressure regulation module output connection for the purpose of brake slip regulation, and may be controlled by the integrated electronic control unit within the scope of the first redundancy on the basis of the electrical signal in such a manner that it adapts the redundancy service brake pressure for the purpose of brake slip regulation.

At least one second ABS pressure control valve may also be arranged in a pneumatic pressure line between the first structural unit output connection and a pneumatic input of the at least one electro-pneumatic pressure regulation module. The second ABS pressure control valve may then be controlled by the integrated electronic control unit within the scope of the first redundancy on the basis of the electrical signal in such a manner that it adapts the redundancy service brake pressure for the purpose of brake slip regulation.

The first ABS pressure control valve and/or the second ABS pressure control valve may be electrically connected to the first electrical structural unit output connection.

In particular, a single pressure control valve may be provided on at least one axle or for at least one axle of the motor vehicle and the brake slip regulation may comprise select low regulation in which the brake slip regulation is performed on this axle in accordance with the wheel having the higher slip of the two wheels of the axle.

The ABS pressure control valves may have the same or a different design. The common feature is that they are designed to maintain, reduce and increase pressure in order to thereby regulate brake slip occurring and detected at the relevant wheel or wheels.

The electro-pneumatic structural unit and in particular the integrated electronic control unit of the electro-pneumatic structural unit may also be designed and configured such that the pneumatic brake pressure output at the second structural unit output connection within the scope of the second redundancy is modulated for the purpose of brake slip regulation. For this purpose, ABS routines may be implemented in the integrated electronic control unit.

The electrical service brake request signal may be generated by a foot brake module and/or by an autopilot device used to control at least partially autonomous driving of the motor vehicle.

In order to achieve the failsafe behavior of the electro-pneumatic brake device, the integrated electronic control unit of the electro-pneumatic structural unit may monitor the primary service brake control unit and/or the at least one pressure regulation module of the electro-pneumatic service brake device for faults and may activate the first redundancy if a fault in normal operation of the electro-pneumatic service brake device is identified and may then activate the second redundancy if a fault in the first redundancy is identified.

A “brake” coupling head for the trailer, in particular, may be connected to the third pneumatic structural unit output connection.

A first electrical energy source may be provided in the electro-pneumatic brake device and is independent of a second electrical energy source. At least the primary service brake control unit and the at least one pressure regulation module can then be supplied with electrical energy by the first electrical energy source. In contrast, at least the electro-pneumatic structural unit can be supplied with electrical energy by the second electrical energy source. At least one ABS pressure control valve of the ABS pressure control valves can be supplied with electrical current either by the first electrical energy source or by the second electrical energy source or by the first electrical energy source and the second electrical energy source. This also increases the functional reliability of the electro-pneumatic brake device.

The invention also relates to a motor vehicle, in particular a towing vehicle designed to couple at least one trailer, having an electro-pneumatic brake device described above.

Advantageous developments of the invention emerge from the patent claims, the description and the drawings. The advantages of features and of combinations of a plurality of features mentioned in the introductory part of the description are merely exemplary and may take effect alternatively or cumulatively, without the advantages necessarily having to be achieved by embodiments according to the invention. Further features can be gathered from the drawings, in particular the geometries shown and the relative dimensions of a plurality of components with respect to one another and their relative arrangement and operative connection. It is likewise possible to combine features of different embodiments of the invention or features of different patent claims in a manner deviating from the selected dependency references of the patent claims and this is hereby suggested. This also relates to those features which are shown in separate drawings or are mentioned in the description of the latter. These features can also be combined with features of different patent claims. Features mentioned in the patent claims may also be dispensed with for further embodiments of the invention.

The invention is now explained by way of example on the basis of a preferred embodiment with reference to the accompanying drawings.

### BRIEF DESCRIPTION OF THE DRAWINGS

FIG. 1 is a schematic illustration of an electro-pneumatic structural unit GSAT according to one preferred embodiment of the invention;

FIG. 2 is a schematic circuit diagram of an electro-pneumatic brake device according to one preferred embodiment of the invention;

FIG. 3 is a schematic circuit diagram of a further part of the electro-pneumatic brake device from FIG. 2 with the electro-pneumatic structural unit from FIG. 1 as a component part; and

FIG. 4 is a schematic circuit diagram of a further part of the electro-pneumatic brake device from FIG. 2 with the electro-pneumatic structural unit from FIG. 1 as a component part.

### DETAILED DESCRIPTION OF THE DRAWINGS

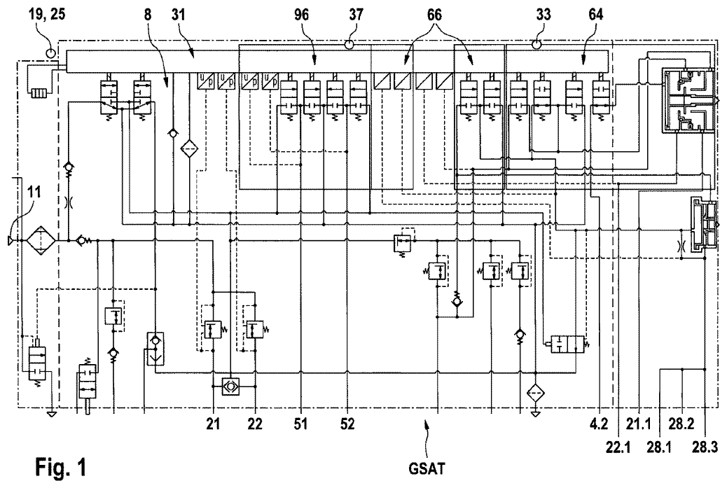

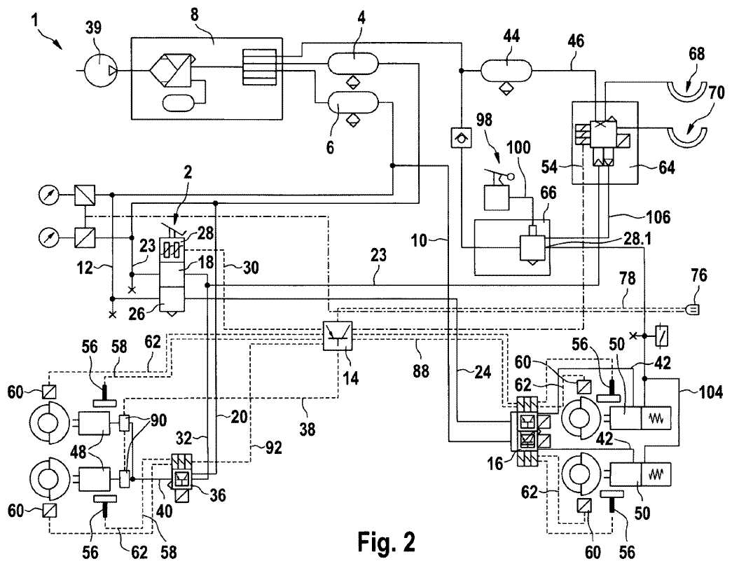

FIG. 1 shows a schematic illustration of an electro-pneumatic structural unit GSAT according to one preferred embodiment of the invention. The electro-pneumatic structural unit GSAT is a component part of an electro-pneumatic brake device 1 of a towing vehicle, which is partially shown in FIG. 2, and is designed and configured, inter alia, to here provide two redundancies, for example, for an electro-pneumatic service brake device of the electro-pneumatic brake device 1 when normal operation of the electro-pneumatic service brake device 1 is not possible. The electro-pneumatic structural unit GSAT is provided here in the electro-pneumatic brake device 1 in addition to an electronically regulated brake system (EBS) that here forms, for example, the electro-pneumatic service brake device.

The electro-pneumatic structural unit GSAT here comprises, for example, a housing 17, indicated in FIG. 1 by a dot-dashed frame, having a first electrical structural unit input connection 19 for introducing an electrical service brake request signal, a second electrical structural unit input connection 25 for introducing an electrical parking brake request signal, and here for example two first pneumatic structural unit output connections 51, 52 for outputting a pneumatic redundancy service brake pressure to pneumatic service brake cylinders 48, 50.

The electro-pneumatic structural unit GSAT also here comprises, for example, three second pneumatic structural unit output connections 28.1, 28.2, 28.3 for outputting a pneumatic parking brake pressure to pneumatic spring-loaded brake cylinders 94. Said connections are arranged or formed on the housing 17. The first and second electrical structural unit input connections 19, 25 may together be formed by a single data bus connection which is then provided for connection to a CAN bus, via which the service brake request signal and the parking brake request signal are fed in and are introduced from there into an integrated electronic control unit 31 of the electro-pneumatic structural unit GSAT. Various functions are implemented in the electronic control unit using software and will be discussed later.

The electro-pneumatic structural unit GSAT also comprises a first structural unit device 96 which is controlled by the electronic control unit, comprises a plurality of solenoid valves, for example, and is connected to the first pneumatic structural unit output connections 51, 52, as well as a second structural unit device 66 which is controlled by the electronic control unit 31, likewise comprises solenoid valves and is connected to the second structural unit output connections 28.1, 28.2, 28.3.

The electronic control unit 31 is designed to control the second structural unit device 66, within the scope of a parking brake function, on the basis of the electrical parking brake request signal introduced at the data bus connection 19, 25, to output a pneumatic parking brake pressure for the spring-loaded brake cylinders 94 at the second structural unit output connections 28.1, 28.2 and 28.3.

Routines for forming the first and second redundancy are implemented in the electronic control unit 31 in order to control components and elements of an electro-pneumatic brake device 1 schematically shown in FIG. 2 to FIG. 4 in the sense of this first and second redundancy.

FIG. 2 shows a schematic circuit diagram of a part of the electro-pneumatic brake device 1 comprising an electro-pneumatic service brake device and an electro-pneumatic parking brake device. This electro-pneumatic service brake device is here preferably in the form of an electronically regulated brake system (EBS) which is electrically controlled/regulated during normal operation. The electro-pneumatic brake device 1 is provided and designed here for a towing vehicle/trailer combination consisting of a towing vehicle and a coupled trailer.

During normal electrical operation, the electronically regulated brake system (EBS) generates a primary service brake pressure and introduces the latter into pneumatic service brake cylinders 48, 50 of the electro-pneumatic brake device 1 in order to implement the service brake request predefined by the electrical service brake request signal. This service brake pressure is “primary” because it is generated in the primary normal electrical operation of the electronically regulated brake system (EBS). The generation of this primary service brake pressure is explained in more detail in the description of FIG. 2 mentioned further below.

During normal electrical operation, driving dynamics regulation functions, for example ABS regulation, are also performed within the electronically regulated brake system (EBS). If faults or defects occur in a first electrical energy supply, the control system and/or in electrical/electronic components of the electronically regulated brake system (EBS), a primary service brake pressure cannot be generated and the driving dynamics regulation functions, such as ABS regulation, cannot be performed. Normal electrical operation is therefore no longer possible either.

Within the scope of the first redundancy, when normal operation of the electronically regulated brake system (EBS) is not possible, the electronic control unit 31 controls the first structural unit device 96 on the basis of the electrical service brake request signal in such a manner that a redundancy service brake pressure is output at the first pneumatic structural unit output connections 51, 52 in order to engage the service brake cylinders 48, 50. The redundancy service brake pressure is then a substitute service brake pressure for the primary service brake pressure.

Although unlikely, the situation in which the first redundancy cannot be performed either, for example because the first structural unit device 96 and/or its for example separate second electrical energy supply has a fault, is now conceivable and possible. The second redundancy then comes into effect. In the second redundancy, the integrated electronic control unit 31 controls the second structural unit device 66 on the basis of the electrical service brake request signal in such a manner that the pneumatic parking brake pressure is output at the second pneumatic structural unit output connections 28.1, 28.2, 28.3 in order to engage the spring-loaded brake cylinders 94.

Within the scope of the second redundancy, when both normal operation of the electronically regulated brake system (EBS) is not possible and the first redundancy has failed, that is to say when a redundancy service brake pressure can no longer be generated either, a parking brake brake pressure is consequently output by the electro-pneumatic structural unit GSAT in order to engage the spring-loaded brake cylinders 94 (in metered fashion) during requested service braking on the basis of the brake request signal. The requested service braking is therefore performed in the second redundancy using the spring-loaded brake cylinders 94 instead of using the service brake cylinders 48, 50. In the exemplary embodiment in FIG. 2, spring-loaded brake cylinders 94 are arranged only on the rear axle within the electro-pneumatic brake device. In addition, however, spring-loaded brake cylinders 94 may also be arranged on the front axle and are then likewise engaged in the second redundancy.

The electro-pneumatic structural unit GSAT is also designed and configured, on the one hand, to perform or control the parking brake brake function during normal operation and in the two redundancies, which parking brake function here involves, for example, engaging and releasing the parking brake or venting and ventilating the spring-loaded brake cylinders 94. For this purpose, the second structural unit device 66 is integrated in the electro-pneumatic structural unit GSAT and the parking brake control functions are implemented in the electronic control unit 31. In order to perform the parking brake control functions, the electronic control unit 31 then controls the second structural unit device 66 to generate a parking brake pressure.

On the other hand, the electro-pneumatic structural unit GSAT is designed and configured to control the electronically regulated brake system (EBS) of the electro-pneumatic brake device 1 within the scope of the first and second redundancy. Consequently, all control and regulation functions of the first and second redundancy are preferably combined here in the electro-pneumatic structural unit GSAT.

Furthermore, the electro-pneumatic structural unit GSAT makes it possible for a journey or operation of the towing vehicle or of a combination of the towing vehicle and at least one trailer to be able to be continued both in the first redundancy and in the second redundancy at an undiminished high speed in relation to normal operation, because ABS regulation, in particular, is provided within the first and second redundancy and therefore there is no degradation of the slip regulation in the first and second redundancy.

In order to implement driving dynamics regulation functions, the electro-pneumatic structural unit GSAT may comprise at least one third electrical structural unit input connection 33. This third electrical structural unit input connection 33 is then designed to introduce at least wheel speed signals from wheel speed sensors 56 into the integrated electronic control unit 31. In addition, the third electrical structural unit input connection 33 may be designed to introduce rotation rate signals representing a rotation rate of the towing vehicle into the integrated electronic control unit 31 and/or to introduce steering angle signals representing a steering angle or steering wheel angle of the towing vehicle into the integrated electronic control unit 31. A plurality of third electrical structural unit input connections 33 may also be provided for this purpose, wherein each third electrical structural unit input connection 33 is then assigned to one of the signals mentioned above.

In particular, at least the wheel speed signals from the wheel speed sensors 56 of all four wheels of the towing vehicle are introduced into the integrated electronic control unit 31 via the third electrical structural unit input connection 33 in order to enable, on the basis thereof, ABS brake slip regulation in the first redundancy and in particular also in the second redundancy.

This makes it possible for the electronic control unit 31 integrated in the electro-pneumatic structural unit GSAT to be able to perform, on the basis of the signals mentioned above, in particular on the basis of at least the wheel speed signals, driving dynamics regulation, in particular an ABS function and/or traction regulation (ASR) and/or a driving stability function (ESP), which is then implemented, for example, using software in the integrated electronic control unit 31.

For this purpose, the electro-pneumatic structural unit GSAT may have a first electrical structural unit output connection 37 for ABS pressure control valves 90, 110 shown in FIG. 1 to FIG. 4 in order to output ABS control signals to the ABS pressure control valves 90, 110 via the first electrical structural unit output connection 37 on the basis of the signals introduced at the third electrical structural unit input connection 33, in particular wheel speed signals.

The ABS pressure control valves 90, 110 then adapt, on the basis of the ABS control signals, the redundancy service brake pressure output by the electro-pneumatic structural unit GSAT within the scope of the first redundancy and preferably also the parking brake pressure output within the scope of the second redundancy in pressure reduction, pressure maintenance and pressure increase phases in order to adapt the actual brake slip recorded using the wheel speeds to a target brake slip.

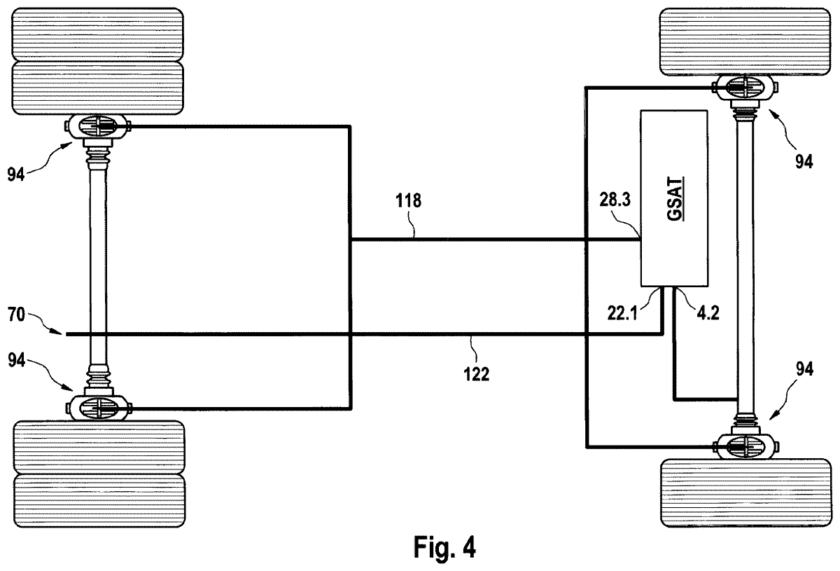

According to the preferred embodiment, the electro-pneumatic structural unit GSAT also comprises a third structural unit device 64 having solenoid valves as well as third pneumatic structural unit output connections 4.2, 22.1, 21.1 connected to the third structural unit device 64. The integrated electronic control unit 31 is then designed to control the third structural unit device 64 on the basis of the electrical service brake request signal in such a manner that a pneumatic trailer brake pressure for the trailer of the towing vehicle is generated at the third pneumatic structural unit output connections 4.2, 21.1, 22.1. A “brake” coupling head 70 for the trailer, in particular, may be connected to a third pneumatic structural unit output connection 22.1 via a pressure line (FIGS. 1 and 4).

Therefore, trailer control routines for controlling the trailer, in particular the trailer brakes, are implemented in the integrated electronic control unit 31 and are then effective both during normal operation and in the first and second redundancy. Consequently, the trailer brakes can then also be engaged in the first and second redundancy during service braking with the aid of the electro-pneumatic structural unit GSAT.

Further preferably, the electro-pneumatic structural unit GSAT optionally also comprises an integrated fourth structural unit device 8 which is designed and provided for the purpose of performing compressed air treatment functions such as circuit separation, pressure regulation and air drying. The fourth structural unit device 8 then corresponds to a compressed air treatment device, wherein the compressed air treatment control routines are implemented in the electronic control unit 31. The fourth structural unit device 8 comprises solenoid valves, in particular. The integrated electronic control unit 31 is then designed to perform the compressed air treatment functions, for example pressure regulation and/or air drying, by controlling the fourth structural unit device 8. The fourth structural unit device 8 may then comprise, in particular, a pressure regulator, an air dryer and a multi-circuit protection valve. The electro-pneumatic structural unit GSAT also has a pneumatic structural unit input connection 11 which is provided for connection to a compressed air outlet of a compressor 39 (FIG. 2) and is then connected to the fourth structural unit device 8.

The fourth structural unit device 8 integrated in the electro-pneumatic structural unit GSAT here supplies, for example, as an electro-pneumatic compressed air treatment device, a first compressed air reservoir 6 for the rear axle and a second compressed air reservoir 4 for the front axle with compressed air and, for this purpose, has two structural unit reservoir connections 21, 22 which are connected to the fourth structural unit device 8. In this case, a first structural unit reservoir connection 21 is provided in order to be connected to the first compressed air reservoir 6, and a second structural unit reservoir connection 22 is provided in order to be connected to the second compressed air reservoir 4.

The electro-pneumatic brake device 1 therefore has a two-circuit design here, for example, wherein a first circuit forms, for example, a rear axle brake circuit which is supplied with compressed air by the first reservoir pressure of the first compressed air reservoir 6. Furthermore, a front axle brake circuit and a trailer brake circuit are provided, for example, as a second circuit and are supplied with compressed air here, for example, by the second reservoir pressure of the second compressed air reservoir 4.

The structure and the function of the electro-pneumatic brake device 1 according to one preferred embodiment are explained below with reference to FIG. 2, wherein, as already mentioned above, its electro-pneumatic service brake device is preferably in the form of an electronically regulated brake system (EBS) here.

In order to facilitate an overview and understanding, the structural unit devices actually integrated in the electro-pneumatic structural unit GSAT, specifically the second structural unit device 66, the third structural unit device 64 and the fourth structural unit device 8, are also each shown separately in FIG. 2. Pneumatic connections between these structural unit devices 8, 64, 66 are then internal pneumatic connections within the electro-pneumatic structural unit GSAT.

In the embodiment of the electronically regulated brake system (EBS) preferred here, a two-channel pressure regulation module 16 is present on the rear axle and a one-channel pressure regulation module 36 is present on the front axle, having, for each channel, an integrated inlet valve/outlet valve combination, a backup valve, a relay valve and a pressure sensor for detecting the actual brake pressure and a local electronic control unit or brake pressure regulator for comparing the actual brake pressure with a target brake pressure according to the respective electrically introduced brake request signal. The two-channel pressure regulation module 16 then regulates the brake pressures for the right-hand and left-hand rear wheel separately, and the one-channel pressure regulation module 36 regulates the brake pressure for the right-hand and left-hand front wheel together.

The structure and the function of such pressure regulation modules 16, 36 are sufficiently well known and shall therefore not be explained any further here.

The electronically regulated brake system (EBS) of the towing vehicle also comprises brake slip regulation (ABS), the ABS control routines of which are preferably integrated in a central electronic EBS brake control unit 14. Furthermore, traction regulation (ASR) and an electronic stability program (ESP) are preferably present here in the electronically regulated brake system (EBS), wherein the relevant control routines are likewise implemented in the central brake control unit 14.

According to the circuit diagram of the electro-pneumatic brake device 1 of the towing vehicle shown in FIG. 2, a foot brake module 2 here having a foot brake pedal as a service brake actuating element 3 for generating the service brake request signal is present, for example. However, the service brake request signal can also be generated by a control device which autonomously controls the vehicle. The air supply, air treatment (air drying) and the protection are carried out here by the fourth structural unit device 8 which is integrated here in the electro-pneumatic structural unit GSAT and embodies a compressed air treatment device.

The first compressed air reservoir 6 for the rear axle is connected, on the one hand, to a reservoir connection of the two-channel pressure regulation module 16 for the service brake cylinders 50 of the rear axle and to a rear axle channel 26 of the foot brake module 2 via pneumatic supply lines 10, 12. In a similar manner, the second compressed air reservoir 4 is connected to a reservoir connection of the one-channel pressure regulation module 36 assigned to the brake cylinders 48 of the front wheels and to a front axle channel 18 of the foot brake module 2 via a pneumatic supply line 20.

The foot brake module 2 here optionally comprises two pneumatic channels 18, 26 which each generate a pneumatic backup pressure or control pressure at the outputs of the channels 18, 26 on the basis of a brake request predefined by the driver's foot on the foot brake pedal 3. In a parallel manner, an electrical front axle channel and an electrical rear axle channel are combined in an electrical channel 28 in the foot brake module 2 and each introduce, on the basis of the brake request, an electrical brake request signal into an electrical connection, preferably in the form of a database 30, between the electrical channel 28 of the foot brake module 2 and the central electronic EBS brake control unit 14, which can distinguish the two brake request signals for the front axle and the rear axle which differ, for example, on account of the load distribution. The electrical brake request signal is also introduced in a parallel manner into the first electrical structural unit input connection 19 of the electro-pneumatic structural unit GSAT (FIG. 1).

Furthermore, the front axle channel 18 and the rear axle channel 26 of the foot brake module 2 are each connected to associated backup connections of the two-channel pressure regulation module 16 and of the one-channel pressure regulation module 36, respectively, via a pneumatic first and third pressure line 24, 32. Furthermore, a pneumatic brake line 40, 42 respectively leads from working connections of the two-channel pressure regulation module 16 and of the one-channel pressure regulation module 36 to the wheel pneumatic service brake cylinders 48, 50 of the front axle and rear axle, respectively.

Speed sensors 56 report the current speed of the wheels of the towing vehicle, here in the form of a two-axle vehicle for example, to the central brake control unit 14 via electrical signal lines 58. Wear sensors 60 are likewise preferably provided for each wheel brake and, on the basis of the current brake wear, report signals to the central brake control unit 14 via electrical signal line 62.

Furthermore, the third structural unit device 64 in the form of a trailer control device is supplied with compressed air, on the one hand, by a trailer reservoir pressure container 44 on the towing vehicle side via a supply line 46 and, on the other hand, is pneumatically controlled by a backup pressure from the pneumatic control pressure from the front axle channel 18 of the foot brake module 2, for example, via a second pressure line 23. For this purpose, the second pressure line 23 is connected to a further pneumatic structural unit input connection that is not shown in FIG. 1 in order to be able to pneumatically control the third structural unit device 64 in a pneumatic redundancy.

Furthermore, the third structural unit device 64 also receives an electrical trailer control signal from the central EBS brake control unit 14 via an electrical control line 54 which is likewise connected, for example, to the first electrical structural unit input connection 19. Furthermore, the third structural unit device 64 is pneumatically controlled by the second structural unit device 66, which is in the form of a parking brake device here, via an internal pneumatic connection 106 of the electro-pneumatic structural unit GSAT. Finally, the third structural unit device 64 loops the compressed air coming from the trailer compressed air reservoir 44 through to a “reservoir” coupling head 68 of the towing vehicle at reservoir pressure.

The third structural unit device 64 contains an inlet solenoid valve and an outlet solenoid valve as well as a backup solenoid valve for controlling the pressure of a relay valve which is likewise integrated and is fed with compressed air by the trailer compressed air reservoir 44, in order to output a control pressure for the “brake” coupling head 70 via these solenoid valves and the relay valve on the basis of a trailer control signal introduced via the electrical control line 54. The relay valve modulates the brake pressure for the “brake” coupling head 70 from the reservoir pressure of the trailer reservoir pressure container 44, which is present at its reservoir connection, on the basis of the control pressure formed by the solenoid valves. This control pressure for the “brake” coupling head 70 is measured by means of a pressure sensor integrated in the third structural unit device 64 and is reported to the central brake control unit 14.

If the primary electrical control by the central brake control unit 14 fails, the integrated backup solenoid valve turns on and the integrated relay valve is controlled, within the scope of the pneumatic redundancy, by the pneumatic backup pressure of the front axle brake circuit carried in the second pressure line 23.

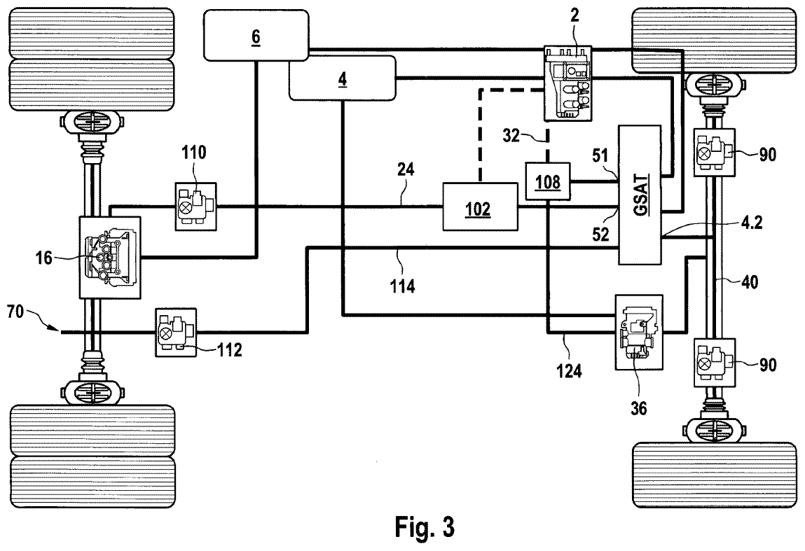

The brake engagement devices of the rear axle are preferably in the form of known combination cylinders, that is to say in the form of a combination of an active service brake cylinder 50 and a passive spring-loaded brake cylinder 94 (combination cylinder). In this context, “active” means that the service brake cylinders 50 engage during ventilation and release during venting and “passive” means that the spring-loaded brake cylinders engage during venting and release during ventilation. Only active service brake cylinders 48, for example, are provided here on the wheels of the front axle. Alternatively, spring-loaded brake cylinders 94 may likewise be provided there (FIG. 3, FIG. 4).

The electro-pneumatic two-channel pressure regulation module 16 for the rear axle, which is in the form of a structural unit, has two pressure regulation channels which can be regulated separately, wherein a regulated working pressure for the brake cylinders 50 of the rear axle, which is present at the respective working pressure connections, is generated for each pressure regulation channel on the basis of a reservoir pressure coming from the first compressed air reservoir 6 depending on the brake request signal from the foot brake module 2 and is measured by means of the integrated pressure sensors in order to adapt or adjust the measured actual brake pressures to the target brake pressure according to the service brake request. In contrast, in the one-channel pressure regulation module 36 of the front axle, a brake pressure for both brake cylinders 48 of the wheels of the front axle is regulated.

In order to form pressure regulation channels with separate pneumatic circuits (for example here: front axle pressure regulation channel and rear axle pressure regulation channel), each pressure regulation channel is consequently assigned its own compressed air reservoir 4, 6, wherein the pneumatic flow paths of each pressure regulation channel are formed so as to be pneumatically separate from the pneumatic flow path of a respective other pressure regulation channel starting from the assigned compressed air reservoir 4, 6, via the assigned pressure regulation modules 16, 36, to the assigned service brake cylinders 48, 50.

Furthermore, a first ABS pressure control valve 90 controlled by the central brake control unit 14 through an electrical control line 38 is respectively arranged in the brake lines 40 between the one-channel pressure regulation module 36 and the service brake cylinders 48. The first ABS pressure control valves 90 are designed to maintain, reduce and increase pressure in order to thereby individually regulate brake slip occurring and detected at the relevant front wheel for the purpose of brake slip regulation.

In order to form an electronically regulated brake system (EBS) having primarily electrically actuated pressure regulation channels (front axle pressure regulation channel and rear axle pressure regulation channel) and a subordinate pneumatic fallback level if the electrics fail, each pressure regulation module 16, 36 is particularly preferably assigned its own pneumatic backup circuit, each having a backup solenoid valve for each channel for introducing a pneumatic backup or control pressure which is derived from the reservoir pressure of the compressed air reservoir 4, 6 assigned to the respective pressure control loop of the rear axle and the front axle and formed by the foot brake module 2 and from which the respective brake pressure is formed at the working pressure connections of the pressure regulation modules 16, 36 if electrical/electronic components fail. However, this pneumatic fallback level or the pneumatic redundancy may also be optionally dispensed with.

The electro-pneumatic brake device 1 of the towing vehicle and the brake device of the trailer, for example with brake slip regulation, are coupled to one another, as is conventional in such brake systems, by means of the “reservoir” coupling head 68 and by means of the “brake” coupling head 70. The electrical brake request signal is transmitted from the central brake control unit 14, via a “trailer” CAN bus 78 and an electronic trailer interface 76, to the trailer if the latter has an electro-pneumatic brake system. The third structural unit device 64 as well as the two-channel pressure regulation module 16 and the one-channel pressure regulation module 36 are each controlled by the central brake control unit 14 via an electrical control line 54, 88, 92.

The trailer is likewise provided here, for example, with an electro-pneumatic brake system with an ABS function. In this case, the electrical interface 76 of the towing vehicle is connected, via a data connection, for example a cable, to a complementary interface in the trailer that leads to an ABS control unit in the trailer, in order to be able to exchange data. Brake slip regulation is therefore performed for all axles of the trailer. If, however, as preferred, the wheel brake slip is determined by means of wheel speed sensors on only one axle of the two-axle semitrailer, for example, the brake slip on the other axle not provided with wheel speed sensors is regulated according to the one axle having wheel speed sensors. This may then result in the disadvantages described at the outset with regard to the locking of the brakes of the other axle without wheel speed sensing and the associated lack of lateral guidance of the wheels of this other axle.

The second structural unit device 66, which forms a parking brake device, is likewise controlled by the electronic control unit 31 of the electro-pneumatic structural unit GSAT, which then receives electrical parking brake request signals from a parking brake actuating device 98, which signals are introduced via an electrical control line 100 via the second electrical structural unit input connection 25 into the electronic control unit 31 which then controls the second structural unit device 66 on the basis of the parking brake request signals. The parking brake request signals are generated on the basis of actuation of a parking brake actuating element. This parking brake actuating element is typically a lever, a rocker switch or a push button and is usually actuated by the driver using his hand.

In this respect, the parking brake control routines are integrated in the electronic control unit 31. The second structural unit device 66 comprises, for example, at least one bistable solenoid valve, a relay valve and a pressure sensor. A second structural unit output connection 28.1 of the second structural unit device 66 is then connected to the spring-loaded brake cylinders 94 of the rear axle via a pneumatic line 104. The second structural unit device 66 pneumatically controls the third structural unit device 64 via the internal pneumatic connection 106 of the electro-pneumatic structural unit GSAT, as has already been mentioned above.

As is clear from FIG. 3, which illustrates components of the electro-pneumatic brake device 1 which are not shown in FIG. 2, a first select high valve 102 is provided, for example, and forwards the greater pneumatic pressure of the pressure output by the electro-pneumatic structural unit GSAT at the first structural unit output connections 52 and the pressure output by the pneumatic rear axle channel 26 of the foot brake module 2 to the first pressure line 24 which is connected to the backup connection of the two-channel pressure regulation module 16 on the rear axle.

Furthermore, a second select high valve 108 is provided, for example, and forwards the greater pneumatic pressure of the pressure output by the electro-pneumatic structural unit GSAT at the first structural unit output connections 51 and the pressure output by the pneumatic front axle channel 18 of the foot brake module 2 via the third pressure line 32 to a seventh pressure line 124 which is connected to the backup connection of the one-channel pressure regulation module 36 of the front axle.

A second ABS pressure control valve 110 is connected to the first pressure line 24. Furthermore, a third ABS pressure control valve 112, for example, is connected to a fourth pressure line 114 leading from the first pneumatic structural unit output connection 52 to the “brake” coupling head 70. The second ABS pressure control valve 110 is controlled by the integrated electronic control unit 31 of the electro-pneumatic unit GSAT for the purpose of at least brake slip regulation. In addition, a third pneumatic structural unit output connection 4.2 of the third pneumatic structural unit output connections 4.2, 21.1, 22.2 is connected to the brake line 40 on the front axle. The third pressure control valve 112 is preferably controlled by the central brake control unit 14 of the EBS in order to modulate the trailer brake pressure for the purpose of brake slip regulation if the electro-pneumatic unit GSAT or its integrated electronic control unit 31 fails.

For reasons of clarity, the second ABS pressure control valve 110, the third ABS pressure control valve 110 and the two select high valves 102, 108 are not shown in FIG. 2.

As shown in FIG. 4, a fifth pressure line 118 may be provided and extends between a second pneumatic structural unit output connection 28.3 of the second pneumatic structural unit output connections 28.1, 28.2, 28.3 of the electro-pneumatic structural unit GSAT and the spring-loaded brake cylinders 94. Furthermore, a sixth pressure line 122 may also be provided and extends between a third pneumatic structural unit output connection 22.1 of the third pneumatic structural unit output connections 4.2, 21.1, 22.1 of the electro-pneumatic structural unit GSAT and the “brake” coupling head 70.

The central brake control unit 14 and the two pressure regulation modules 16, 36 and the first ABS pressure control valves 90 are supplied with electrical energy, for example, by a first electrical energy supply which is not shown here. In contrast, the electro-pneumatic structural unit GSAT, the first ABS pressure regulation modules 90 and the second and third ABS pressure control valves are supplied with electrical energy by a second electrical energy supply which is not shown here and is independent of the first electrical energy supply.

Against this background, the method of operation of the brake device 1 is as follows:

### Normal Operation

During a braking process, the driver actuates the brake pedal and thus the foot brake module 2, as a result of which, during normal operation, an electrical brake request signal similar to the desired target deceleration or the driver's brake request is generated in the electrical channel 28 and is introduced into the central brake control unit 14 which then respectively introduces a signal for a target brake pressure optionally into the electronic control unit 31 of the electro-pneumatic unit GSAT, into the two-channel pressure regulation module 16 of the rear axle and the one-channel pressure regulation module 36 of the front axle via the electrical control lines 54, 88, 92 according to the brake request signal and possibly on the basis of further parameters such as the respective load distribution. However, during normal operation, the electronic control unit 31 of the electro-pneumatic unit GSAT preferably has no influence on the service brake of the towing vehicle.

In this case, solenoid valves and backup solenoid valves which are respectively integrated in the pressure regulation modules 16, 36 and in the third structural unit device 64 and are usually in the form of 2/2-way solenoid valves are switched according to the brake request so that they pneumatically control the relay valves that are likewise integrated in order to introduce a target brake pressure corresponding to the brake request into the relevant brake cylinders 48, 50 of the towing vehicle or, via the “brake” coupling head 70, into the brake cylinders of the trailer. The pressure sensors integrated in the pressure regulation modules 16, 36 and in the third structural unit device 64 then report the actual brake pressure or the actual control pressure to local electronic control units in the pressure regulation modules 16, 36 or to the electronic control unit 31 of the electro-pneumatic structural unit GSAT, in which case the respective target brake pressure is then adjusted by controlling the solenoid valves. During normal operation, the electro-pneumatic unit GSAT is preferably used as a type of “gateway” for the functionality of the trailer brakes, that is to say the electro-pneumatic unit GSAT receives the brake request signal and outputs a corresponding trailer brake pressure at the “brake” coupling head 70. This trailer brake pressure can be detected using sensors and can be fed back to the electro-pneumatic unit GSAT in order to implement pressure regulation, in particular within the scope of the EBS.

If, instead of being generated by the foot brake module 2, the brake request signal for the central brake control unit 14 is generated by a driving assistance system acting independently of the driver, for example an ESP (Electronic Stability Program), an ACC (Adaptive Cruise Control), an emergency brake assistant or by a control device of an autopilot for at least partially autonomous driving, the service brake functions take place as described above.

If the brake slip of a wheel or of a plurality of wheels of the towing vehicle and/or of the trailer exceeds a predefined brake slip limit of 12% to 14%, for example, which can be identified using the wheel speed sensors 56, the brake slip regulation or the ABS of the towing vehicle responds. In this case, the brake pressures for the towing vehicle are set by appropriately controlling the first ABS pressure control valves 90 on the front axle or the pressure regulation module 16 on the rear axle by means of the ABS routines implemented in the central EBS brake control unit 14 in such a manner that the brake slip regulation difference is adjusted.

Compatibility bands which define the relationship between the respectively desired braking z of the towing vehicle/trailer combination and the resulting brake force of the trailer or the pressure at the “brake” coupling head of the towing vehicle are stored in the central EBS brake control unit 14. The brake pressure for the brake system of the trailer that results from the compatibility band can then be optionally also modified by coupling force regulation. The trailer control module 64 is then controlled by the central brake control unit 14 to set the pneumatic control pressure in the “brake” coupling head 70 for the trailer according to these specifications. The brake pressure in the trailer would therefore be formed on the basis of the brake pressure in the towing vehicle that is influenced by the brake slip regulation.

In summary, the brake pressure of the brake system of the trailer, which is dependent, in terms of its absolute value, on the brake request signal or on the predefined target deceleration of the towing vehicle/trailer combination, on the responding brake slip regulation (coefficient of friction of the road surface) of the towing vehicle, on the towing vehicle/trailer compatibility band and possibly also on available coupling force regulation, therefore then forms a reference brake pressure for the brake system of the trailer. Instead of a reference brake pressure, it is also possible to use a reference brake force of the trailer or reference braking of the trailer, which relates to the same circumstances described above.

If, after braking the towing vehicle/trailer combination by means of the electronically regulated brake system (EBS) to a vehicle standstill within the scope of the normal parking brake function, the parking brake actuating device 98 is actuated into the “park” position, a corresponding parking brake request signal is introduced into the electronic control unit 31 of the electro-pneumatic structural unit GSAT which then controls the integrated second structural unit device 66 to vent the structural unit output connection 28.1 of the electro-pneumatic structural unit GSAT and therefore also, via the line 104, the spring-loaded brake cylinders 94 which then engage. The third structural unit device 64 of the electro-pneumatic structural unit GSAT is also vented via the internal connection 106, wherein the third structural unit device 64 then ventilates the “brake” coupling head 70 according to its inverting property in order to engage the trailer brakes.

### (Optional) Pneumatic Redundancy

If, for example, the first electrical energy supply fails and/or if a fault in the central brake control unit 14 and/or in one of the pressure regulation modules 16, 36 is detected by external monitoring or self-monitoring, the primary electrical primary control circuit, and therefore the electrical normal operation of the electronically regulated brake system (EBS), is disrupted. It is then possible to use, for example, a purely pneumatic redundancy brake circuit which is controlled solely by the driver.

In the purely pneumatic redundancy brake circuit, the backup pressures introduced into the first pressure line 24 and the second pressure line 23 by the foot brake module 2 flow through the backup valves of the pressure regulation modules 16, 36, which are then open without current, and then flow from the pressure regulation modules 16, 36 into the pneumatic brake cylinders 48, 50 on the front axle and on the rear axle for engagement.

Since the first ABS pressure control valves 90, the second ABS pressure control valve 110 and optionally also the third ABS pressure control valve 112 are preferably supplied with electrical current by the second electrical energy supply and/or by the electro-pneumatic structural unit GSAT, they remain functional even after failure of the first electrical energy supply. Alternatively, the third ABS pressure control valve 112 may also be supplied with electrical energy only by the first electrical energy supply. Furthermore, the wheel speed signals from the wheel speed sensors 56 are still introduced into the electronic control unit 31 of the electro-pneumatic structural unit GSAT. Consequently, ABS regulation is also possible with the pneumatic redundancy. Depending on the expansion stage with respect to sensors (steering angle sensor, yaw rate sensor, longitudinal/lateral acceleration sensor) and ABS pressure control valves, an expansion of functions can be provided such that driving dynamics regulation (ESP) is additionally also possible.

With reference to FIG. 3, in this case the electronic control unit 31 of the electro-pneumatic unit GSAT can modulate the first ABS pressure control modules 90 on the front axle and the second ABS pressure control valve 110 arranged upstream of the two-channel pressure regulation module 16 on the rear axle for the purpose of brake slip regulation. On the rear axle, for which only a single second ABS pressure control valve 110 is then provided here for example, the ABS can be regulated, for example, according to the “select low” or “select high” principle. Further ABS pressure control valves can be installed on the output side of the rear axle pressure regulation module 16 in order to regulate the rear axle from the GSAT in a wheel-specific manner. Since the functionality of the trailer brake pressure control is also integrated in the electro-pneumatic unit GSAT, the integrated electronic control unit 31 can control the solenoid valves of the third structural unit device 64, which are provided for this function, to regulate the trailer brake pressure using brake slip. The actually purely pneumatic redundancy then preferably comprises ABS regulation, for example of at least one axle and preferably of all axles of the towing vehicle here, and also ABS regulation of the trailer.

The third pressure control valve 112 shown in FIG. 3 and arranged in the fourth pressure line 114 is used, for example, as described above, to modulate the trailer brake pressure at the “brake” coupling head 70 if the electro-pneumatic unit GSAT, and in particular its electronic control unit 31, has failed. For this purpose, the third pressure control valve 112 is preferably controlled by the EBS or its central brake control unit 14.

### First Electrical Redundancy

Within the scope of the first electrical redundancy, the electro-pneumatic structural unit GSAT generates pneumatic backup pressures corresponding to the service brake request signal which is generated either by the driver via the foot brake module 2 and/or by a control device of a driver assistance system (ACC, autopilot etc.). The second pressure control valve 110 is preferably arranged here in the pressure line 24 laid from the electro-pneumatic structural unit GSAT to the pressure regulation modules 16 of the rear axle and is controlled, for example, on the basis of wheel speed signals from the speed sensors 56 to preferably implement brake slip regulation (ABS), traction regulation (ASR) and/or driving dynamics regulation (ESP). The trailer brake pressure, which is dependent on the service brake request signal, is preferably applied to the “brake” coupling head 70 directly by the electro-pneumatic structural unit GSAT. The third pressure control valve 112 is open or switched through for this purpose, for example.

Therefore, an electro-pneumatic redundancy brake circuit is provided, in which the pneumatic backup control pressures for the electronic pressure regulation modules 16, 36 are generated by the electro-pneumatic structural unit GSAT on the basis of the brake request signal introduced into the electro-pneumatic structural unit GSAT and are output to the first structural unit output connections 51, 52 and are then passed into the pneumatic inputs of the electronic pressure regulation modules 16, 36 via the first and seventh pressure lines 24, 124.

Therefore, the first electrical redundancy is used for the situations in which the normal electrical operation of the electronically regulated brake system (EBS) is disrupted and there is no pneumatic redundancy (for example on account of a lack of pneumatic channels 18, 26 in the foot brake module 2), or pneumatic redundancy is prevented (for example owing to the absence of a reaction by the driver) or is disrupted and consequently no or no sufficient pneumatic backup pressures are generated. This is because, as indicated above, the foot brake module 2, for example, may not have a pneumatic front axle channel 18 and may not have a pneumatic rear axle channel 26 and/or the pneumatic backup pressures of the pneumatic redundancy have failed or are too low.

Within the scope of the first electrical redundancy, the electronic control unit 31 of the electro-pneumatic structural unit GSAT controls the first structural unit device 96 to introduce the redundancy service brake pressures into the pneumatic inputs of the two select high valves 102 and 108 via the first pneumatic structural unit output connections 51, 52.

When no backup control pressures or excessively low backup control pressures are then present at the respective other pneumatic inputs of the two select high valves 102 and 108, which are connected to the pneumatic front axle channel 18 and the pneumatic rear axle channel 26, the redundancy service brake pressures introduced into the pneumatic inputs of the two select high valves 102 and 108 by the electro-pneumatic structural unit GSAT via the first pneumatic structural unit output connections 51, 52 are higher than the backup pressures and are then forwarded from the two select high valves 102, 108 into the first pneumatic pressure line 24 and into the seventh pneumatic pressure line 124.

Since the first ABS pressure control valves 90, the second ABS pressure control valve 110 and optionally also the third ABS pressure control valve 112 are supplied with electrical current by the second electrical energy supply, they remain functional even after failure of the first electrical energy supply. Furthermore, the wheel speed signals from the wheel speed sensors 56 are still introduced into the electronic control unit 31 of the electro-pneumatic structural unit GSAT because the wheel speed sensors 56 are connected thereto. Consequently, ABS regulation is also possible with the first electrical redundancy.

In this case too, the electronic control unit 31 of the electro-pneumatic unit GSAT then preferably controls the first ABS pressure control modules 90 on the front axle and the second ABS pressure control valve 110 arranged upstream of the two-channel pressure regulation module 16 on the rear axle in such a manner that the respective redundancy service brake pressures for the front axle, the rear axle and the trailer are modulated for the purpose of brake slip regulation. On the rear axle, for which only a single second ABS pressure control valve 110 is provided here for example, the ABS can be regulated, for example, according to the “select low” or “select high” principle. The first electrical redundancy then also comprises ABS regulation of all axles of the towing vehicle and also of the trailer here, for example.

If no optional pneumatic redundancy is provided, it is also possible to dispense with the two select high valves 102, 108 from FIG. 3. In this case, the redundancy service brake pressures are passed from the electro-pneumatic structural unit GSAT directly into the first pneumatic pressure line 24 and into the seventh pneumatic pressure line 124 via the first pneumatic structural unit output connections 51, 52.

### Second Electrical Redundancy

If the electro-pneumatic structural unit GSAT has a fault, for example, at the level of the first electrical redundancy, for example in integrated sensors (for example pressure sensors) or actuators (for example solenoid valves), the second electrical redundancy comes into effect. The second electrical redundancy then implements the parking brake, the brake slip of which is regulated here, for example, in one channel on the basis of the signals from the speed sensors 56 which are then still available. The “brake” coupling head 70 is directly supplied with trailer brake pressure by the electro-pneumatic structural unit GSAT within the scope of the second electrical redundancy.

If no primary normal operation of the electronically regulated brake system (EBS) is therefore possible, no pneumatic redundancy is provided or is disrupted and the first electrical redundancy is not effective, the second electrical redundancy of the electronically regulated brake system (EBS) is used.

As already stated above, with the second electrical redundancy, the electro-pneumatic structural unit GSAT outputs a pneumatic brake brake pressure in order to engage (in metered fashion) the spring-loaded brake cylinders 94 during requested service braking depending on the brake request signal. Instead of being carried out using the service brake cylinders 48, 50, the requested service braking is therefore carried out in the second redundancy using the spring-loaded brake cylinders 94, specifically on the basis of the service brake request signal

In order to achieve a higher brake force, combination cylinders with integrated spring-loaded brake cylinders 94 may also be arranged on the front axle and may be controlled by the electro-pneumatic structural unit GSAT for the purpose of the parking brake function and also within the second redundancy (FIG. 3, FIG. 4).

Furthermore, the wheel speed signals from the wheel speed sensors 56 are also introduced into the electronic control unit 31 of the electro-pneumatic structural unit GSAT which supplies the active wheel speed sensors 56, for example, with current. Consequently, ABS regulation is also possible with the second electrical redundancy. Since the functionality of a trailer control module TCM is integrated (software and hardware) in the electro-pneumatic structural unit GSAT, the trailer brake pressure can be generated and modulated at the “brake” coupling head 70, at least within the scope of the second electrical redundancy, by means of the electro-pneumatic structural unit GSAT on the basis of the brake request signal, in particular for the purpose of brake slip regulation (ABS).

Consequently, at least two electrical redundancies for an electronically regulated brake system (EBS) of the electro-pneumatic brake device 1 are possible with the electro-pneumatic structural unit GSAT from FIG. 1 within an electro-pneumatic brake device 1.

### LIST OF REFERENCE SIGNS

1 Electro-pneumatic brake device
2 Foot brake module
3 Service brake actuating element
4 Second compressed air reservoir
4.2 Third pneumatic structural unit output connection
6 First compressed air reservoir
8 Fourth structural unit device (compressed air treatment device)
10 Supply line
11 Pneumatic structural unit input connection
12 Supply line
14 Central brake control unit
16 Two-channel pressure regulation module
17 Housing
18 Front axle channel
19 First electrical structural unit input connection
20 Supply line
21 First pneumatic structural unit reservoir connection
22 Second pneumatic structural unit reservoir connection
21.1, 22.1 Third pneumatic structural unit output connections
23 Second pressure line
24 First pressure line
25 Second electrical structural unit input connection
26 Rear axle channel
28 Electrical channel
28.1, 28.2, 28.3 Second pneumatic structural unit output connections
30 Data bus
31 Electronic control unit
32 Third pressure line
33 Third electrical structural unit input connection
36 One-channel pressure regulation module
37 First electrical structural unit output connection
38 Electrical control line
39 Compressor
40 Brake line
42 Brake line
44 Trailer reservoir pressure container on the towing vehicle side
46 Supply line
48 Front axle service brake cylinder
50 Rear axle service brake cylinder
51 First structural unit output connection
52 First structural unit output connection
54 Electrical control line
56 Speed sensors
58 Electrical signal lines
60 Wear sensors
62 Electrical signal lines
64 Third structural unit device (trailer control device)
66 Second structural unit device (parking brake control device)
68 “Reservoir” coupling head
70 “Brake” coupling head
76 Trailer interface
78 Trailer data bus
88 Electrical control line
90 First ABS pressure control valve
92 Electrical control line
94 Spring-loaded brake cylinder
96 First structural unit device
98 Parking brake actuating device
100 Electrical control line
102 First select high valve
104 Pneumatic line
106 Pneumatic connection
108 Second select high valve
110 Second ABS pressure control valve
112 Third ABS pressure control valve
114 Fourth pressure line
118 Fifth pressure line
122 Sixth pressure line
124 Seventh pressure line
GSAT Electro-pneumatic structural unit

1.-26. (canceled)

27. An electro-pneumatic structural unit (GSAT) configured to control an electro-pneumatic brake device (1) in at least two redundancies, a first redundancy and a second redundancy, for an electro-pneumatic service brake device (EBS) of the electro-pneumatic brake device (1) of a motor vehicle designed to tow a trailer, when normal operation of the electro-pneumatic service brake device, in which a primary service brake pressure is generated by the electro-pneumatic service brake device, is not possible, the electro-pneumatic structural unit comprising:
a) a first electrical structural unit input connection (19) for introducing an electrical service brake request signal;
b) a first pneumatic structural unit output connection (51, 52) for outputting a pneumatic redundancy service brake pressure to a pneumatic service brake cylinder (48, 50);
c) a second pneumatic structural unit output connection (28.1, 28.2, 28.3) for outputting a pneumatic brake pressure to a pneumatic spring-loaded brake cylinder (94);
d) an integrated electronic control unit (31) controlled by the electrical service brake request signal introduced at the first electrical structural unit input connection (19);
e) a first structural unit device (96) which is controlled by the integrated electronic control unit (31), the first structural unit device comprising a solenoid valve and being connected to the first pneumatic structural unit output connection (51, 52);
f) a second structural unit device (66) which is controlled by the integrated electronic control unit (31), the second structural unit device comprising a solenoid valve and being connected to the second structural unit output connection (28.1, 28.2, 28.3),
g) wherein the integrated electronic control unit (31) is configured to:
g1) control the first structural unit device (96) within the scope of the first redundancy, when normal operation of the electro-pneumatic service brake device is not possible or is disrupted, on the basis of the electrical service brake request signal introduced at the first electrical structural unit input connection (19) such that the redundancy service brake pressure is output at the first structural unit output connection (51, 52) in order to engage the service brake cylinder (48, 50), and
g2) control the second structural unit device (66) within the scope of the second redundancy, when normal operation of the electro-pneumatic service brake device is not possible and the first redundancy has also failed, on the basis of the electrical service brake request signal introduced at the first electrical structural unit input connection (19) such that the pneumatic brake pressure is output at the second structural unit output connection (28.1,

28. 2, 28.3) in order to engage the spring-loaded brake cylinder (94).

28. The electro-pneumatic structural unit as claimed in claim 27, further comprising:
a second electrical structural unit input connection (25) for introducing an electrical parking brake request signal,
wherein the integrated electronic control unit (31) is configured to:
control the second structural unit device (66), within the scope of a parking brake function, on the basis of the electrical parking brake request signal introduced at the second electrical structural unit input connection (25), to output a pneumatic parking brake pressure at the second structural unit output connection (28.1, 28.2, 28.3).

29. The electro-pneumatic structural unit as claimed in claim 28, further comprising:
a third electrical structural unit input connection (33) configured to introduce at least one electrical signal into the integrated electronic control unit (31),
wherein the electrical signal is at least one of the following electrical signals:
a wheel-speed-dependent signal representing a wheel speed of at least one wheel of the motor vehicle and/or of the trailer,
a rotation-rate-dependent signal representing a rotation rate of the motor vehicle and/or of the trailer,
a steering-angle-dependent signal representing a steering angle or steering wheel angle of the motor vehicle, or
a longitudinal-acceleration-dependent or lateral-acceleration-dependent signal representing a longitudinal and/or lateral acceleration of the motor vehicle and/or of the trailer.

30. The electro-pneumatic structural unit as claimed in claim 29, wherein the electro-pneumatic structural unit is configured to process at least some of the electrical signals received at the third electrical structural unit input connection (33) for regulating vehicle dynamics and/or driving stability.

31. The electro-pneumatic structural unit as claimed in claim 29, further comprising:
a first electrical structural unit output connection (37) for at least one ABS pressure control valve (90, 110).

32. The electro-pneumatic structural unit as claimed in claim 31, wherein
ABS regulation is implemented in the integrated electronic control unit (31), which is designed to output an electrical control signal for the at least one ABS pressure control valve (90, 110) to the first electrical structural unit output connection (37) at least based on at least one electrical signal introduced at the third electrical structural unit input connection (33).

33. The electro-pneumatic structural unit as claimed in claim 32, wherein the integrated electronic control unit (31) is configured such that at least one regulation process of the following regulation processes is performed within the scope of the first redundancy and/or within the scope of the second redundancy:
ABS regulation,
ASR regulation, or
ESP regulation.

34. The electro-pneumatic structural unit as claimed in claim 27, further comprising:
a third structural unit device (64) having a solenoid valve;
a third pneumatic structural unit output connection (4.2, 21.1, 22.1) connected to the third structural unit device (64),
wherein the integrated electronic control unit (31) is configured to control the third structural unit device (64) based on the electrical service brake request signal such that a pneumatic trailer brake pressure for at least one trailer of the motor vehicle is generated at the third pneumatic structural unit output connection (4.2, 21.1, 22.1).

35. The electro-pneumatic structural unit as claimed in claim 34, further comprising:
a fourth structural unit device (8) having a solenoid valve,
wherein the integrated electronic control unit (31) is configured to perform at least one compressed air treatment function by controlling the fourth structural unit device (8).

36. The electro-pneumatic structural unit as claimed in claim 35, further comprising:
a structural unit reservoir connection (21, 22) connected to the fourth structural unit device (8) for supplying compressed air from at least one compressed air reservoir (4, 6).

37. An electro-pneumatic brake device (11) for a motor vehicle suitable for coupling a trailer, comprising:
a) the electro-pneumatic structural unit (GSAT) as claimed in claim 29; and
b) the electro-pneumatic service brake device (EBS) comprising:
b1) a primary service brake control unit (14);
b2) an electro-pneumatic pressure regulation module (16, 36) electrically controlled by the primary service brake control unit (14); and
b3) the service brake cylinder (48, 50), which is connected to a pneumatic pressure regulation module output connection of the pressure regulation module (16, 36), wherein
the primary service brake control unit (14) electrically controls the pressure regulation module (16, 36), based on the electrical service brake request signal, to output the primary service brake pressure at the pressure regulation module output connection.

38. The electro-pneumatic brake device as claimed in claim 37, further comprising:
an electro-pneumatic parking brake device comprising at least the pneumatic spring-loaded brake cylinder (94), which is connected to the second pneumatic structural unit output connection (28.1, 28.2, 28.3), and an electrical parking brake actuating device (98), the integrated electronic control unit (31) and the second structural unit device (66) of the electro-pneumatic structural unit (GSAT),
wherein the integrated electronic control unit (31) of the electro-pneumatic structural unit (GSAT) controls the second structural unit device (66) of the electro-pneumatic structural unit (GSAT), based on the electrical parking brake request signal generated by the electrical parking brake actuating device (98) and introduced into the second electrical structural unit input connection (25) of the electro-pneumatic structural unit (GSAT), to output the pneumatic parking brake pressure to at least one pneumatic spring-loaded brake cylinder (94) at the second pneumatic structural unit output connection (28.1, 28.2, 28.3).

39. The electro-pneumatic brake device as claimed in claim 38, further comprising at least one of the following sensors:
a) a wheel speed sensor configured to generate wheel-speed-dependent signals,
b) a rotation rate sensor configured to generate rotation-rate-dependent signals,
c) a steering angle sensor configured to generate steering-angle-dependent signals, or
d) an acceleration sensor configured to generate longitudinal-acceleration-dependent and/or lateral-acceleration-dependent signals.

40. The electro-pneumatic brake device as claimed in claim 39, wherein the electro-pneumatic structural unit (GSAT) is configured to directly receive and process signals from the at least one sensor at the third electrical structural unit input connection (33), wherein at least one of:
a) the wheel speed sensor is connected to the third electrical structural unit input connection (33) of the electro-pneumatic structural unit,
b) the rotation rate sensor is connected to the third electrical structural unit input connection (33) of the electro-pneumatic structural unit,
c) the steering angle sensor is connected to the third electrical structural unit input connection (33) of the electro-pneumatic structural unit, or
d) the acceleration sensor is connected to the third electrical structural unit input connection (33) of the electro-pneumatic structural unit.

41. The electro-pneumatic brake device as claimed in claim 39, wherein
the electro-pneumatic structural unit (GSAT) is configured to process the signals from the at least one sensor and to indirectly receive signals from a further electronic control unit of the motor vehicle, via a data bus, to which the electro-pneumatic structural unit and the further electronic control unit are connected.

42. The electro-pneumatic brake device as claimed in claim 37, further comprising:
a first ABS pressure control valve (90) arranged between the pressure regulation module output connection of the pressure regulation module (16, 36) and the pneumatic service brake cylinder (48, 50).

43. The electro-pneumatic brake device as claimed in claim 42, wherein the first ABS pressure control valve (90) is controlled by:
a) the primary service brake control unit (14) during normal operation based on the electrical signal so as to adapt the primary service brake pressure output at the pressure regulation module output connection for the purpose of brake slip regulation, and
b) the integrated electronic control unit (31) within the scope of the first redundancy based on the electrical signal so as to adapt the redundancy service brake pressure for the purpose of brake slip regulation.

44. The electro-pneumatic brake device as claimed in claim 42, further comprising:
a second ABS pressure control valve (110) in a pneumatic pressure line (24) between the first structural unit output connection (51, 52) and a pneumatic input of the at least one electro-pneumatic pressure regulation module (16).

45. The electro-pneumatic brake device as claimed in claim 44, wherein
the second ABS pressure control valve (110) is controlled by the integrated electronic control unit (31) within the scope of the first redundancy based on the electrical signal so as to adapt the redundancy service brake pressure for the purpose of brake slip regulation.

46. The electro-pneumatic brake device as claimed in claim 45, wherein
a brake coupling head (70) is connected to the third pneumatic structural unit output connection (21.1).

47. The electro-pneumatic brake device as claimed in claim 46, wherein
the electro-pneumatic structural unit (GSAT) is configured to generate, at the third pneumatic structural unit output connection (21.1), a brake pressure for the trailer that is regulated or controlled with respect to driving stability and/or driving dynamics of the motor vehicle and/or of the trailer.

48. The electro-pneumatic brake device as claimed in claim 37, wherein
the integrated electronic control unit (31) of the electro-pneumatic structural unit (GSAT) is configured such that the pneumatic brake pressure output at the second structural unit output connection (28.1, 28.2, 28.3), within the scope of the second redundancy, is modulated for regulating brake slip.

49. The electro-pneumatic brake device as claimed in claim 37, wherein
a foot brake module (2) and/or an autopilot device is/are provided and generate(s) the electrical service brake request signal.

50. The electro-pneumatic brake device as claimed in claim 37, wherein
the integrated electronic control unit (31) monitors the primary service brake control unit (14) and/or the pressure regulation module (16, 36) for faults and activates the first redundancy when a fault is identified.

51. The electro-pneumatic brake device as claimed in claim 37, wherein
a first electrical energy source is provided and is independent of a second electrical energy source, and
a) at least the primary service brake control unit (14) and the pressure regulation module (16, 36) are supplied with electrical energy by the first electrical energy source, and wherein
b) at least the electro-pneumatic structural unit (GSAT) is supplied with electrical energy by the second electrical energy source.

52. A towing vehicle designed to couple with a trailer, comprising an electro-pneumatic brake device (1) as claimed in claim 37.
